(19) United States
(12) Patent Application Publication
(10) Pub. No.: US 2015/0133073 A1
(43) Pub. Date: May 14, 2015

(54) Emergency Catastrophic Communication System

(71) Applicants: Robert A. K. Mitchell, Alpine, CA (US); Lance G. Newquist, Kihei, HI (US)

(72) Inventors: Robert A. K. Mitchell, Alpine, CA (US); Lance G. Newquist, Kihei, HI (US)

(21) Appl. No.: 14/539,404

(22) Filed: Nov. 12, 2014

Related U.S. Application Data
(60) Provisional application No. 61/904,305, filed on Nov. 14, 2013.

(51) Int. Cl. H04W 4/22; H04W 4/08; H04B 7/185

(52) U.S. Cl. CPC H04W 4/22; H04B 7/18506; H04W 4/08
USPC 455/404.1

(57) ABSTRACT

A method, apparatus, and system in which a communications architecture is designed to provide two-way communications to general public and government subscribers during a catastrophic event when landline and cellular communications are disrupted. A communications architecture includes an airborne platform deployed during a catastrophic event, a communications system housed on the airborne platform, one or more receive and transmit antennas mounted on an exterior of the airborne platform, a ground communications control system in a direct or indirect line of sight with the airborne platform, system software to implement a transfer of messages from a subscriber's personal device to the communications system, and device application software installed on the subscriber's personal device.

### CROSS-REFERENCE TO RELATED APPLICATIONS

This application claims the benefit of U.S. Provisional Patent Application No. 61/904,305, filed Nov. 14, 2013, and titled “Emergency Catastrophic Communication System,” which is incorporated herein by reference in its entirety.

### TECHNICAL FIELD

Embodiments of the present invention generally relate to emergency communication systems. More particularly, embodiments of the present invention relate to a reliable emergency communication system for public and government use during an emergency or catastrophic event.

### BACKGROUND

In today's world, there is an increasing demand for instant information. Whereas the receipt of information in written communication took a few days, the world today demands information virtually instantaneously, at one's fingertips.

As the speed of technology increased, from a written communication, to the telegraph, then telephones, then the internet and other wireless communication, people have come to rely on the instant transmission of information over unseen but dependable wireless networks.

People use wireless and cellular networks to send millions of texts, pictures, and videos daily. Wireless networks are pervading the market, and are found not only in users' homes, but in hotels, airports, cafes, and increasingly, city-wide in select cities like Sunnyvale, Austin, and Kansas City. Users are so reliant on wireless and cellular networks that home landline telephones are being replaced by mobile phones, and mobile phones are being used to perform services, like paying bills, searching the Internet, and looking up information, which were once reserved for other channels, like mail, landline telephones, or desktop computers. As such, the growth in wireless communications applications is exponential and worldwide.

This growth and reliance is occurring because of the availability of wireless and cellular networks. Wireless networks are fast, generally reliable, and widespread in use. In addition, cellular providers erect cell sites, frequently cell phone towers, to provide cellular service to their customers. A cell phone may not work at times, because it is too far from a cell network, or because the phone is in a location where cell phone signals are attenuated by thick building walls, hills or other structures. The signals do not need a clear line of sight but greater radio interference will degrade or eliminate reception.

When catastrophic events occur, cellular coverage may be lost entirely. Natural or man-made events like earthquakes, tsunamis, hurricanes, fires, terrorist activities, etc. may result in downed cell phone sites and the amount of people trying to reach out to others may overwhelm the cell network capacity. As a result, the cellular networks become swamped, unusable, or shut down completely. However, this is when communications are the most critical. People could be in immediate danger, or want their loved ones to know they are safe, and their loved ones want to be able to reach those people in turn. Thus, people are totally reliant on a capability that will probably not be there when they need it the most.

In catastrophic events, when power goes down, the network can go down completely, and lives can be in danger. Such situations occurred during the 2004's Indian Ocean earthquake and tsunami, 2005's Hurricane Katrina, 2011's Tohoku earthquake and tsunami, and 2012's Hurricane Sandy. During such events, cellular providers may not be able to obtain physical access to deploy temporary stop-gap capabilities, such as temporary cells on wheels (COW). Even the US Wireless Emergency Alerts (WEA) depend on the integrity of cellular networks. (WEA is a public safety system that allows customers who own certain wireless phone models and other enabled mobile devices to receive geographically-targeted, text-like messages alerting them of imminent threats to safety in their area.)

A number of solutions are possible for contacting others during an emergency. One solution may be a standalone emergency-use only handset, similar to a satellite phone. A satellite phone is a type of mobile phone that connects to orbiting satellites instead of terrestrial cell sites. Satellite phones are popular on expeditions into remote areas where terrestrial cellular service is unavailable. Such a solution requires spectrum allocation. A second solution may include adding a new capability into existing cell phones. This would require reengineering multiple cell phone devices. A third solution may include using the cell frequencies to create an airborne cell network. A fourth solution, which is preferred, includes operating over wireless frequencies. Since every new device is now Wi-Fi enabled, and there is broad coverage of wireless networks, this is a non-invasive approach independent of both the network and the device.

In summary, there is a need for improved direct communications with citizens immediately following a catastrophic event. Potential solutions are currently land based, but an airborne solution may be more effective. A near-term airborne solution is feasible using advanced modern technologies.

### SUMMARY

An Emergency Catastrophic Communications System (ECCS) provides a communications architecture designed to provide two-way communications to general public and government subscribers during an emergency or catastrophic event when landline and cellular communications are disrupted. The communications architecture is configured to cover a large geographical area, such as a major city. In some embodiments, the communications architecture provides two-way communications of narrow-band text messages with an option for wider-band communications, such as by way of example voice communications. Such communications may be provided by way of Wi-Fi-capable cell phones or other personal wireless devices.

In an event of a catastrophe, cellular networks and Internet connectivity may be lost. The ECCS is configured to operate by way of an airborne platform. Using mechanically scanned or electronically scanned antennas with wide-area and narrow-beam capabilities, the system scans geographical areas to identify devices and recognize device addresses, as well as recognize geographic locations. The system identifies pending subscriber messages, determines a priority of service and order of response of the messages, and then uses a narrow-beam to service each subscriber device accordingly. The system is configured to read messages and route them to the Internet via a backhaul link using either a line of sight (LOS) from the airborne platform or a beyond line of sight (BLOS) from the airborne platform through a satellite communications link to a remote ground station and an Internet access point in an area unaffected by the catastrophe. The ECCS is thus configured to route messages between subscribers in a disaster area and people outside the affected area when cellular networks and Internet connectivity have been lost.

In an embodiment, subscribers have an application stored on their devices so as to access the ECCS. The airborne platform patrols the disaster area, scanning for subscriber devices. It is envisioned that the airborne platform may be manned or unmanned. In some embodiments, the ECCS may comprise several applications, including, but not necessarily limited to, applications providing assistance to the Federal Emergency Management Agency (FEMA) and state emergency management agencies.

In some embodiments, a communications link between the airborne platform and the subscriber devices comprises 802.11 Wi-Fi frequency bands so as to connect the subscriber devices to the ECCS via the airborne platform mechanically and electronically scanned antennas. In some embodiments, the backhaul LOS and/or BLOS links utilize existing commercial wideband directional communications links possessing connectivity to an Internet access point in an unaffected area.

### BRIEF DESCRIPTION OF THE DRAWINGS

FIG. 1 is a schematic illustrating an exemplary embodiment of an emergency catastrophic communications system for communicating during an emergency.

FIG. 2 is a flowchart illustrating an exemplary method for communicating during an emergency.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DESCRIPTION

In the following description, numerous specific details are set forth, such as examples of specific data signals, named components, connections, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Further specific numeric references such as first antennae, may be made. However, the specific numeric reference should not be interpreted as a literal sequential order but rather interpreted that the first antennae is different than a second antennae. Thus, the specific details set forth are merely exemplary. The specific details may be varied from and still be contemplated to be within the spirit and scope of the present invention. The term coupled is defined as meaning connected either directly to the component or indirectly to the component through another component.

Embodiments of an Emergency Catastrophic Communications System (ECCS) of the present disclosure are generally directed to a communications architecture configured to provide public and government subscribers with two-way communications during catastrophic events during which landline and cellular communications may be disrupted. Communications primarily are by way of text messages, but are not necessarily limited thereto, and thus may also comprise voice, images, video, and other similar forms of electronic communication.

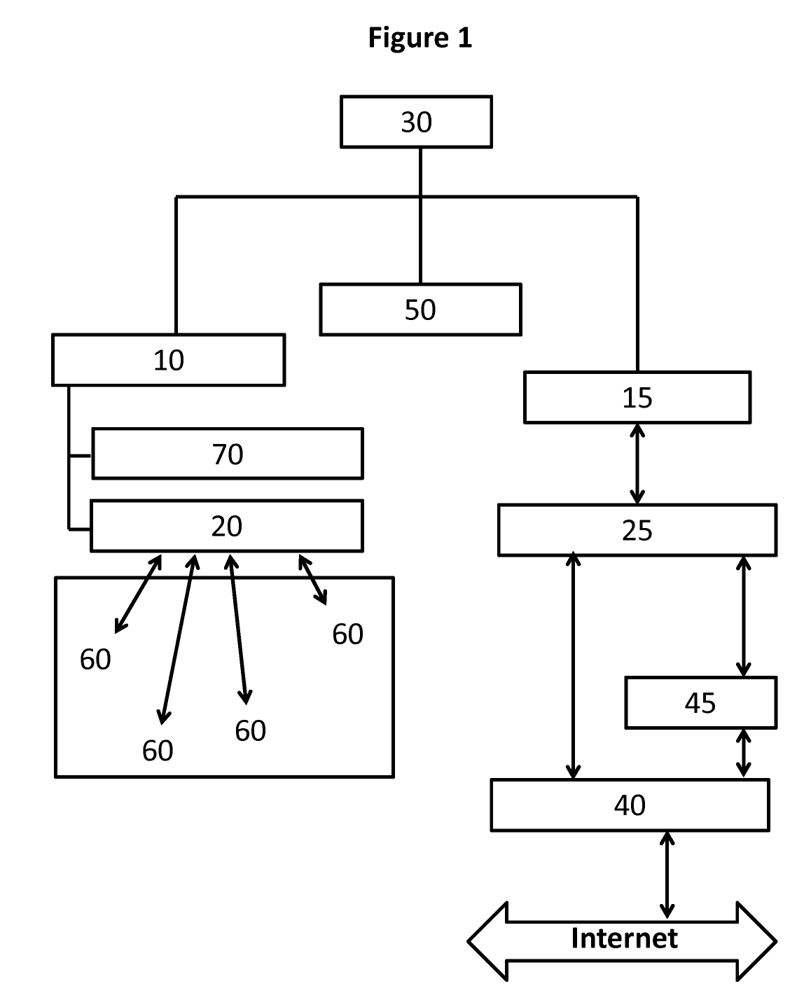

FIG. 1 depicts an exemplary embodiment of an emergency catastrophic communications system, according to the present disclosure. The communications architecture is configured to provide two-way communications to general public and government subscribers during a catastrophic event during which landline and cellular communications may be disrupted. Subscribers may access the ECCS capability by way of personal devices, such as by way of non-limited example, cell phones, tablet computers, laptop computers, e-book readers, and other personal use devices equipped to communicate wirelessly using either existing and future cellular bands and frequencies or existing and future public wireless local area network (e.g., WLAN, or Wi-Fi) bands and frequencies.

As shown in FIG. 1, elements of the communications architecture include a device communications subsystem 10, a backhaul communications subsystem 15, directional receive and transmit device antennas 20, directional receive and transmit backhaul antennas 25, an airborne platform 30, a ground communications control station 40, an onboard hardware and software control system 50, WiFi or cellular enabled devices with a device application software 60, and a message processor 70.

The communications system 10 comprises several hardware units comprise communications receivers, communications transmitters, power supplies, computers, displays and controls, ancillary wiring and connectors, and the like, that are installed onto the airborne platform 30. In an embodiment, at least two sets of directional receive and transmit device antennas 20 are mounted externally onto the airborne platform 30, are connected to the device communications subsystem 10, and are configured to receive and transmit both narrow-beam and wide-beam signals in the existing and future cellular bands and frequencies, or the existing and future public Wi-Fi bands and frequencies. In an embodiment, one or more directional receive and transmit device antennas 20 comprises a directional capability whereby the antennas may be mechanically steered. In another embodiment, the first set of the directional receive and transmit device antennas 20 comprise a directional capability utilizing electronically steered phased array systems that respond to electronic steering phase commands from the onboard hardware and software control system 50 by way of the device communications subsystem 10.

In an embodiment, one or more directional receive and transmit backhaul antennas 25 comprise a backhaul capability configured to receive and transmit signals to/from the ground communications control system 40 either by way of line of sight (LOS) or by way of beyond line of sight (BLOS). As illustrated in FIG. 1, BLOS communications may be via a commercial communications satellite 45. Further, the onboard hardware and software control system 50 generally provides pointing commands to the directional receive and transmit backhaul antennas 25 by way of the backhaul communications subsystem 15.

The airborne platform 30 comprises an aircraft which is modified to carry the device communications subsystem 10 and the directional receive and transmit device antennas 20. The aircraft comprising the airborne platform 30 may be a commercial aircraft, an experimental aircraft, an unmanned air vehicle (UAV), an optionally piloted vehicle (OPV), or any other similar aircraft suitable for carrying the device communications subsystem 10, the backhaul communications subsystem 15, the directional receive and transmit device antennas 20, the directional receive and transmit backhaul antennas 25, and the onboard hardware and software control system 50. The airborne platform modifications preferably include internal equipment racks and structures to house the device communications subsystem 10, the backhaul communications subsystem 15, the onboard hardware and software control system 50, hardware units, cable ducts, clamps and various fasteners, and interface structures suitable for externally mounting the directional receive and transmit device antennas 20, and the directional receive and transmit backhaul antennas 25.

The ground communications control system 40 comprises a hardware and software system that communicates with the airborne platforms 30 either by line of sight (LOS) or beyond line of sight (BLOS) by way of a commercial communications satellite 45 link. The ground communications system 40 preferably comprises a local wide-band internet connection configured to enable message traffic to be sent to and from remote internet users. It is envisioned that the ground communications control system 40 is to be housed in a building or in a vehicle.

The onboard hardware and software control system 50 preferably is stored in the device communications system 10 computer, the ground communications control system 40 computer, as well as other devices that may be utilized in the operation of the ECCS. The onboard hardware and software control system 50 generally controls the device communications system 10 and the ground communications control system 40, providing phase commands and pointing commands to the directional receive and transmit device antennas 20 by way of the device communications subsystem 10. Further, the onboard hardware and software control system 50 computes geographic locations of all personal devices that are active and have the device application software 60 installed. The onboard hardware and software control system 50 uses the geographic location data to calculate pointing vectors from the airborne platform 30 to the personal devices. The onboard hardware and software control system 50 includes displays and controls in the airborne platform 30 and this same capability is also provided in the ground communications control system 40.

The device application software 60 preferably is unique to each type of personal device and enables the personal device to communicate with the airborne platform 30 via the directional receive and transmit device antennas 20 and the device communications subsystem 10. Further, the onboard hardware and software control system 50 provides geographic location information to the displays and controls residing in both the airborne platform 30 and the ground communications control system 40.

Before an emergency occurs, the airborne platforms 30 and the ground communications control systems 40 are positioned in locations that are generally regarded as safe and within reach of major population centers. When a catastrophic event occurs that results in a loss of cellular communications and Internet service across a wide geographical area, such as a major city, the airborne platforms 30 and the ground communications control systems 40 may be deployed. The airborne platforms 30 preferably are flown into an affected area and then follow a suitable path, such as by way of non-limiting example, a circular, racetrack, or figure-8 pattern, so as to maximize line of sight to subscribers possessing personal devices that include the device application software 60. Further, the airborne platforms 30 are flown so as to maintain line of sight with the ground communications control systems 40. The ground communications control systems 40 is located in a safe area that is within the line of sight (LOS) of the airborne platform 30, or can communicate with the airborne platform 30 by way of commercial communications satellites 45 beyond the line of sight (BLOS).

During deployment of the airborne platforms 30, the onboard hardware and software control system 50 commands the system to conduct wide area scanning by way of the directional receive and transmit device antennas 20 so as to locate and identify all subscriber devices in the area with the device application software 60 installed. Once the subscriber devices are located, the system software 20 establishes a two-way link between the airborne platforms 30 and the subscriber devices by way of the directional receive and transmit device antennas 20. Messages to and from the subscriber devices are then routed from the airborne platforms 30 to the ground communications control system 40 via the backhaul communications subsystem 15, and directional receive and transmit backhaul antennas 25, and then to remote recipients by way of Internet routing. It is envisioned that users that subscribe to the ECCS emergency communications system each receive the device application software 60 coupled with a unique identifier configured to identify each user's personal device to the ECCS emergency communications system.

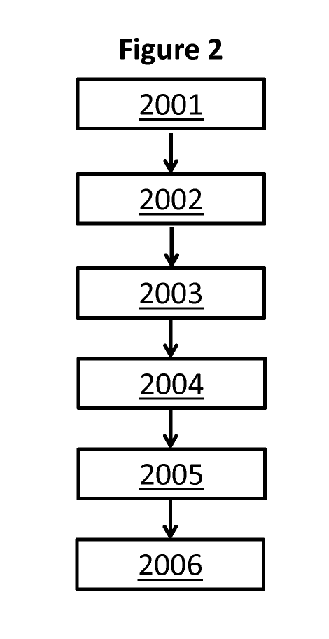

FIG. 2 depicts an exemplary embodiment of a method of communicating using an emergency catastrophic communications system, according to the present disclosure. Airborne platforms 10 and ground communications control system 40 are deployed, as indicated by block 2001. Airborne platforms 10 are flown into the affected area, as indicated by block 2002. The onboard hardware and software control system 50 will command the device communications subsystem 10 to conduct a wide area scan using the directional receive and transmit device antennas 20, as indicated by block 2003. The geographical location of each personal device that has the device application software 60 installed is determined, as indicated by block 2004. The onboard hardware and software control system 50 and device communications subsystem 10 will point the directional receive and transmit device antennas 20 and establish two-way communications with the device application software 60, as indicated by block 2005. Messages to and from the personal devices are routed to remote recipients over the internet via the backhaul communications subsystem 15 from the airborne platform 30 using the directional receive and transmit backhaul antennas 25 by line of sight or via satellite 45 to the ground communications control systems 40, as indicated by block 2006.

Still referring to FIG. 2, in an embodiment, a method of communicating, includes the steps of deploying a communications system on an airborne platform 10 and a ground communications control system 40 on land; flying the airborne platform 10 into a desired area; commanding the communications system 40 to conduct a wide area scan using one or more receive and transmit antennas 20 mounted on the airborne platform 10; locating and identifying one or more personal devices in the desired area having an installed device application software 60; using system software to establish a two-way communications link between the airborne platform 10 and the one or more personal devices by way of the receive and transmit antennas 20; routing one or more messages from the one or more personal devices to the airborne platform 10 and then to the ground communications control system 40; and sending the one or more messages from the ground communications control system 40 to one or more recipients outside of the desired area. The airborne platform 10 may be flown in at least one of a repeating path, a racetrack path, and a circle-8 path. The method further allows for one or more recipients to send messages from the one or more personal devices in the desired area.

In one embodiment, the software used to facilitate the algorithms discussed herein can be embodied onto a non-transitory machine-readable medium. A machine-readable medium includes any mechanism that stores information in a form readable by a machine (e.g., a computer). For example, a machine-readable medium includes read only memory (ROM); random access memory (RAM); magnetic disk storage media; optical storage media; flash memory devices; Digital VideoDisc (DVD's), EPROMs, EEPROMs, FLASH memory, magnetic or optical cards, or any type of media suitable for storing electronic instructions.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages such as C, C+, or other similar languages. Also, an algorithm may be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown the invention is not to be limited to these embodiments. For example, most functions performed by electronic hardware components may be duplicated by software emulation. A combination hardware and software may be used to accomplish a particular function. Thus, a software program written to accomplish those same functions may emulate the functionality of the hardware components in input-output circuitry. The invention is to be understood as not limited by the specific embodiments described herein, but only by scope of the appended claims.

What is claimed:

1. A communications architecture, comprising:
an airborne platform deployed during a catastrophic event;
a communications system housed on the airborne platform;
one or more receive and transmit antennas mounted on an exterior of the airborne platform;
a ground communications control system in a direct or indirect line of sight with the airborne platform;
system software to implement a transfer of messages from a subscriber's personal device to the communications system; and
device application software installed on the subscriber's personal device.

2. The communications architecture of claim 1 configured to provide two-way communications to public and government subscribers during the catastrophic event when landline and cellular communications are disrupted.

3. The communications architecture of claim 1, wherein the subscriber's personal device comprises a cell phone, a tablet, a computer, or an e-book reader.

4. The communications architecture of claim 1, wherein the communications system further comprises a mechanically scanned or electronically scanned antenna with wide-area and narrow-beam capabilities.

5. The communications architecture of claim 1, wherein the airborne platform comprises a commercial aircraft, an experimental aircraft, an unmanned aircraft, or an optionally piloted aircraft.

6. The communications architecture of claim 5, wherein the airborne platform is modified to carry the communications system and the one or more receive and transmit antennas.

7. A method of communicating, comprising the steps of:
deploying a communications system on an airborne platform and a ground communications control system on land;
flying the airborne platform into a desired area;
commanding the communications system to conduct a wide area scan using one or more receive and transmit antennas mounted on the airborne platform;
locating and identifying one or more personal devices in the desired area having an installed device application software;
using system software to establish a two-way communications link between the airborne platform and the one or more personal devices by way of the receive and transmit antennas;
routing one or more messages from the one or more personal devices to the airborne platform and then to the ground communications control system; and
sending the one or more messages from the ground communications control system to one or more recipients outside of the desired area.

8. The method of claim 7, wherein the airborne platform is flown in a repeating path.

9. The method of claim 8, wherein the airborne platform is flown in a racetrack path.

10. The method of claim 8, wherein the airborne platform is flown in a circle-8 path.

11. The method of claim 7, wherein the one or more recipients send messages to the one or more personal devices in the desired area.
